(19) United States
(12) Patent Application Publication
(10) Pub. No.: US 2005/0273393 A1
(43) Pub. Date: Dec. 8, 2005

(54) Method and system for automating selection and tracking of purchase options for property sales transactions

(76) Inventor: David Ibarra, Salt Lake City, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/859,436

(22) Filed: Jun. 2, 2004

(51) Int. Cl. G06F 17/60

(52) U.S. Cl. 705/26

(57) ABSTRACT

Embodiments of the invention including a method and system of automating selection and tracking of purchase options for the goods and/or services associated with sales transactions are disclosed. Computer programs and computer media for storing computer programs implementing embodiments of the method of the present invention are also disclosed.

### BACKGROUND OF THE INVENTION

1. Field of the Invention

This invention relates generally to sales transactions between sellers and buyers of goods and services, and specifically relates to a method and system of automating selection and tracking of purchase options for the goods and/or services associated with sales transactions.

2. Description of Related Art

Sales transactions generally become proportionately more detailed and complicated with the dollar amount associated with the purchase price of the goods and/or services. For example, a simple sales receipt might be the only documentation associated with the sale of groceries from a store. The buyer of such groceries may typically rely on the sales receipt and the grocer's return policy if there is some question about returning the goods associated with the transaction. In contrast, the purchase of a business may involve stacks of paperwork including contracts, representations and warrantees made by the seller, financing and insurance documents, detailed descriptions of the assets involved and even legal opinions regarding aspects of the transaction.

The purchase of a vehicle, for example, may be as simple as a cash transaction and the transfer of title to the vehicle. In this example, suppose the vehicle is a used automobile, so there is no selection of color and/or options. The new owner will be responsible for paying property taxes and insurance where applicable. A more complicated example might be the purchase of a new automobile from a dealer. The sales transaction for a new automobile will typically involve the selection of vehicle options, financing and insurance in addition to the payment of property taxes.

For the common consumer, the various facets of an automobile sales transaction including, for example, vehicle options, financing and insurance, are bewildering and confusing at best. Some automobile dealers have taken advantage of such confusion by slipping in options or terms that, while disclosed to the customer, were not well explained. A significant number of such automobile transactions have resulted in padding of the final sales price with a lack of disclosure that may even rise to the level of fraud. In contrast, other dealers have tried to fully disclose the various options and terms, but were simply hampered by inefficient means of conveying that information.

Fraudulent sales tactics in the automobile industry have caught the attention of various states attorney general offices. See for example, Donna Harris, “Strategy Shift”, Automotive News, Mar. 29, 2004, p. 27-28. As a result, significant fines and restitution have been paid by former fraudulent auto dealers and dealerships. Id. Liability for fraud based on such sales tactics has become a concern for automobile dealers.

Examples of such fraudulent sales tactics include: adding charges for features already included in the vehicle sales price, arranging higher-cost financing with a friendly bank that kicks back money, putting “legroom” in the monthly payment, i.e., setting the monthly payment higher than the amount needed for the loan and then “stuffing” the contract with extras to support the payment, and charging big sums for near-worthless services or features, such as etching of vehicle identification numbers in window glass and changing sales documents after a customer has signed them. See, Harry Stoffer, “‘Dateline’ Whistle-Blower Has Checkered Past”, Automotive News, Dec. 15, 2003, p. 3, 57.

Because of the potential for liability, automobile dealers have been looking for solutions to the problem of educating as well as policing their own sales force to insulate the dealerships from liability. One solution to this problem has been to fully inform the buyer of every optional feature, service and financing arrangement along with the associated cost. Where the buyer has acknowledged the options he has selected and the added cost, there is less chance for fraud and the dealer has a record to defend itself. However, manual attempts to accomplish this task using so called “menu” style folders where the buyer is allowed to select and initial the selections made are cumbersome and do not readily allow for recalculation when selections or changes are made. This lack of ability to recalculate costs on-the-fly has thus been one of the biggest stumbling blocks for a dealer who wants to obey not only the letter of disclosure laws, but the spirit of the laws as well.

Thus, there still exists a need in the art for a method and system of automating selection and tracking of purchase options for the goods and/or services associated with sales transactions.

### BRIEF SUMMARY OF THE INVENTION

It is an object of the present invention to provide a system and method for displaying and summarizing a customer's selections during a property sales transaction.

It is another object to provide a system and method for highlighting a customer's selections so that the selections are obvious to the customer.

It is another object to provide a system and method for recording a customer's selections by printing a summary and then having the customer physically sign a print out of the customer's selections.

An embodiment of a method for automating selection and tracking of purchase options for property sales transactions is disclosed. The method may include presenting a hierarchical list of options associated with purchase of property to a purchaser and reviewing each of the options within the hierarchical list of options. The method may further include recording a purchaser's choices among all of the options and automatically summarizing selected options and highlighting the new cost associated with the property transaction. Embodiments of systems and computer media including implementations of the method of the present invention are also disclosed.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

The following drawings illustrate exemplary embodiments for carrying out the invention. Like reference numerals refer to like parts in different views or embodiments of the present invention in the drawings.

FIG. 1 is a flow chart of a method for automating selection and tracking of purchase options for property sales transactions according to an embodiment of the present invention.

FIG. 2 is a block diagram of a computer media embodiment according to an embodiment of the present invention.

FIG. 3 is a block diagram of a system for automating selection and tracking of purchase options for property sales transactions according to an embodiment of the present invention.

FIGS. 4-22 are screen shots from an exemplary embodiment of a computer program consistent with the present invention wherein the property to be sold is a vehicle.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

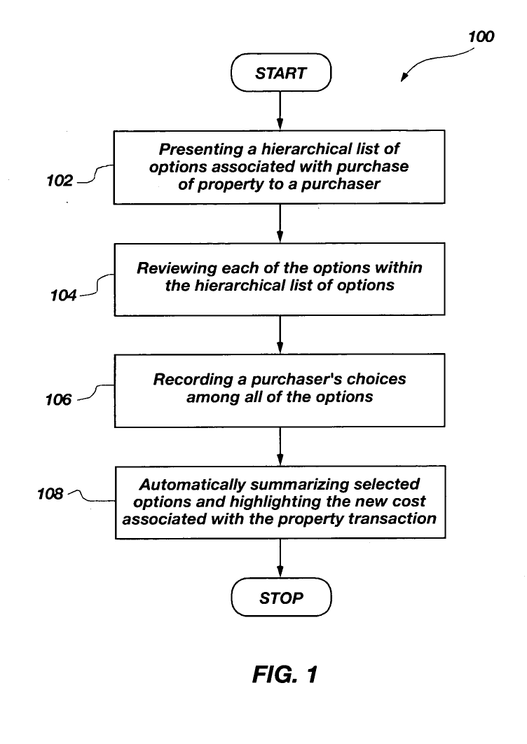

FIG. 1 is a flow chart of a method 100 for automating selection and tracking of purchase options for property sales transactions according to an embodiment of the present invention. Method 100 may include presenting 102 a hierarchical list of options associated with purchase of property to a purchaser and reviewing 104 each of the options within the hierarchical list of options. Method 100 may further include recording 106 a purchaser's choices among all of the options and automatically summarizing 108 selected options and highlighting the new cost associated with the property transaction.

The method 100 of the present invention is of course applicable to sales of property wherein the property is an automobile. However, sales of other sorts of personal and real property are also contemplated within the scope of the present invention.

Presenting 102 a hierarchical list of options may include presenting a plurality of tiers ranging from an all-inclusive tier of options to a minimally-inclusive tier of options associated with the purchase of property according to an embodiment of the present invention. Any number of preselected tiers of options may be included according to other embodiments of the present invention. According to a presently preferred embodiment, method 100 may further include displaying only one of the plurality of tiers at a time. Displaying only one of the plurality of tiers at a time has the advantage of focusing the purchaser on a single set of options and tends not to overwhelm the buyer with too much information at one time.

According to other embodiments of the present invention, presenting 102 a plurality of tiers may include presenting a preferred tier as the all-inclusive tier, a value tier including fewer options than the preferred tier, a basic tier with fewer options than the value tier and an economy tier as the minimally-inclusive tier of options. Of course, other quantities of tiers with variations in scope of options covered are also contemplated and considered within the scope of the present invention. For example, according to yet another embodiment of the present invention presenting 102 a hierarchical list of options may include mandatory disclosure options: extended service plan, guaranteed asset protection and payment protection benefit. Still another embodiment of the present invention may include presenting a hierarchical list of options includes at least one of paint protection, fabric protection, vinyl/leather protection, undercoating and clear bra. Even another embodiment of the present invention may include presenting financing and insurance options.

According to another embodiment of the present invention, method 100 may further include determining a purchaser's temperament. A seller using method 100 can determine a purchaser's temperament for absorbing and processing the various options as being either “fact driven” or “graphical display driven”. The allows the seller using method 100 to down select to a selected tier based on the purchaser's temperament according to another embodiment of the present invention.

According to still another embodiment of the present invention, method 100 may further include recording time duration elapsed during the reviewing each of the options within the hierarchical list of options. In still yet another embodiment of the present invention, method 100 may further include automatically gathering sales data and calculating statistics including time duration and purchaser choices over a plurality of sales. This information, including sales data and statistics on time duration and purchaser choices may be very valuable to a dealership or other sales organization with a sales force using method 100.

For example, according to another embodiment of the present invention, method 100 may further include analyzing the statistics to determine sales personnel compliance with predetermined standard sales procedure. The level of compliance may be used to identify training needs or problem sales personnel or even rewarding sales personnel for being in compliance. According to yet another embodiment of the present invention, method 100 may further include automatically calculating dealership sales performance based on the sales data during selected time periods. Alternatively, method 100 may further include automatically calculating dealership sales performance based on the sales data on a per sale basis, according to another embodiment of the present invention.

According to yet another embodiment of the present invention, method 100 may further include validating a final selection by printing a report, obtaining a purchaser's physical signature and initials for options selected and declined on the report. This feature is particularly advantageous in obtaining a record that the sales personnel provided the various options selected by the purchaser and that the purchaser acknowledged the selections in writing.

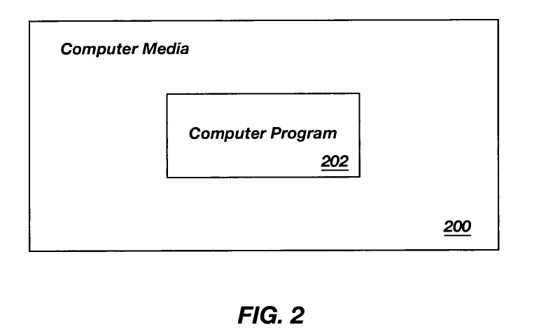

FIG. 2 is a block diagram of a computer media 200 embodiment according to an embodiment of the present invention. Computer media 200 may be used for storing a computer program 202. The computer program 202 may implement method 100 for automating selection and tracking of purchase options for property sales transactions according to an embodiment of the present invention. Method 100 and its various embodiments as implemented by computer program 202 and stored on computer media 200 may be as described above with reference to FIG. 1. Computer media 200 may be physically formed of solid state, magnetic, optical or magneto-optic media or any other suitable media for the storage of computer programmed instructions.

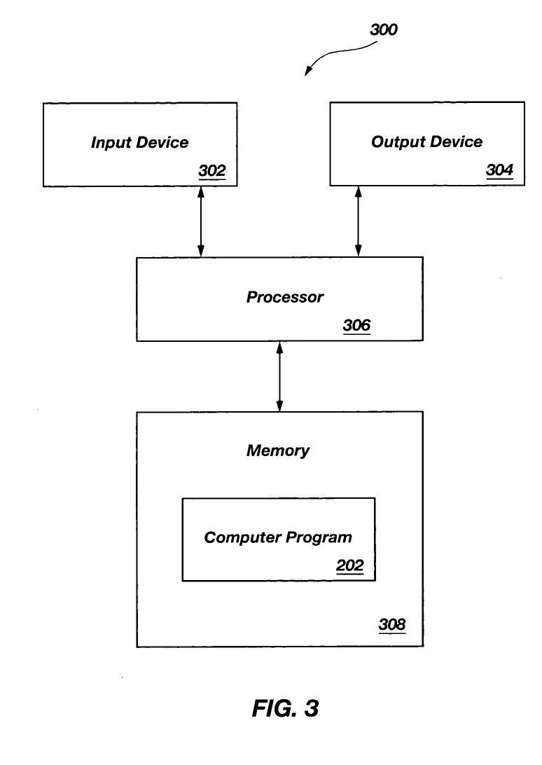

FIG. 3 is a block diagram of a system 300 for automating selection and tracking of purchase options for property sales transactions according to an embodiment of the present invention. System 300 may include an input device 302, an output device 304 and a processor 306 in communication with the input device 302 and the output device. Processor 306 may further be configured to execute a computer program 202. Computer program 202 may implement method 100 as described above. The computer program 202 may be stored in a memory 308 in communication with the processor 306 as shown in FIG. 3. The memory 308 may be any suitable computer memory consistent with embodiments of the present invention. For example, memory 308 may include bulk storage memory, e.g., hard disk drive, or solid state memory, e.g., dynamic random access memory. System 300 may further be configured for remote access and monitoring by communication with a network (not shown in FIG. 3) according to an embodiment of the present invention. System 300 may further be configured for automatically rating sales personnel based on measuring human performance factors.

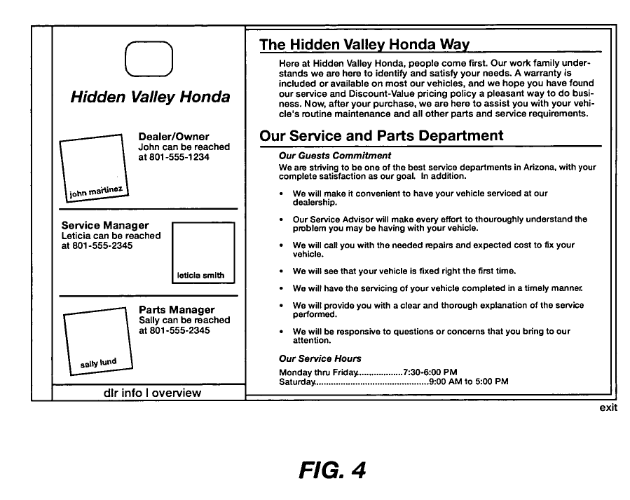

FIGS. 4-17 are screen shots from an exemplary embodiment of a computer program 202 consistent with the present invention wherein the property to be sold is a vehicle. The following discussion explains what features are shown in the various screen shots according to this particular embodiment of the present invention. The particular embodiment of a computer program 202 may be referred to herein as ExpressMenu™.

ExpressMenu™ may be configured as a comprehensive electronic menu selling system for the automotive industry. ExpressMenu™ allows a Finance and Insurance (F&I) presenter the ability to prioritize products for maximum penetration and profitability. The F&I presenter or salesman can customize product offerings that best fit the purchaser's (also referred to herein as “customer's”) needs and when objections or new information emerge, adjustments can quickly be made. A presentation using ExpressMenu™ may be configured for fast and friendly standardized presentation to reduce customer time, apprehension and confusion. Technological features of ExpressMenu™ include: printing disclosure information, may be easily converted to a Spanish language edition and printed menus may be private labeled with the dealership name and logo.

ExpressMenu™ may begin with a scripted presentation of after-the-sale dealer services as shown in FIG. 4. The scripted presentation helps the F&I presenter determine the customer's state-of-mind: apprehensive, negative or cooperative. The presenter also tries to determine the temperament trait of the customer: e.g., Directness, Extroversion, Pace, or Structure. By understanding and then connecting to the customer's correct temperament trait and recognizing the state-of-mind, the presenter is given the best opportunity to present information to the customer in a manner that has been created for specific temperaments and state-of-mind. In other words, the program has the ability to present the same information in different ways because people learn in different ways. Accordingly, using temperament traits with the proper presentation links within ExpressMenu™ that best fits those traits may create fast, friendly and profitable sales transactions.

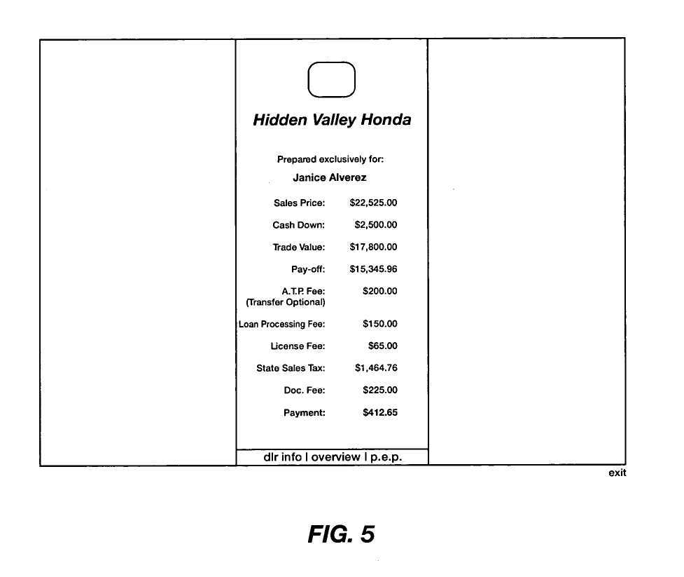

To insure that Federal and State disclosure laws are followed and to manage the customer's state-of-mind (temperament) ExpressMenu™ may next display an up front disclosure of what has been agreed upon thus far during the sales transaction, see FIG. 5. This mandatory step helps protect both the dealer and the customer from an improper sale presentation taking place.

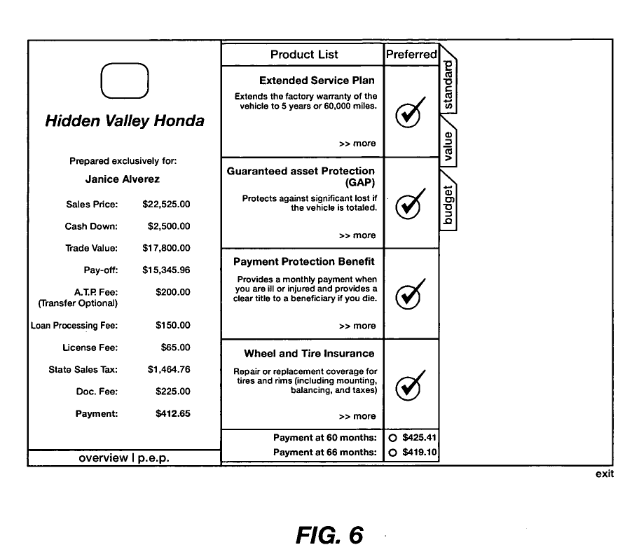

Automobile dealerships are responsible for ensuring that all products are presented in accordance with State and federal discloser laws. Many states are creating laws to protect customers from deceptive sales practices. The ExpressMenu™ software may be configured to ensure that every customer receives a presentation and validates how products were offered and thereby protects both the dealer and the customer from deceptive sales practices. ExpressMenu™ presents products (vehicle options and features) bundled together in typically three to four offering groups. ExpressMenu™ may be configured to present each bundled group (tier) individually, see FIG. 6. Thus, the customer sees the visual offering as it is made.

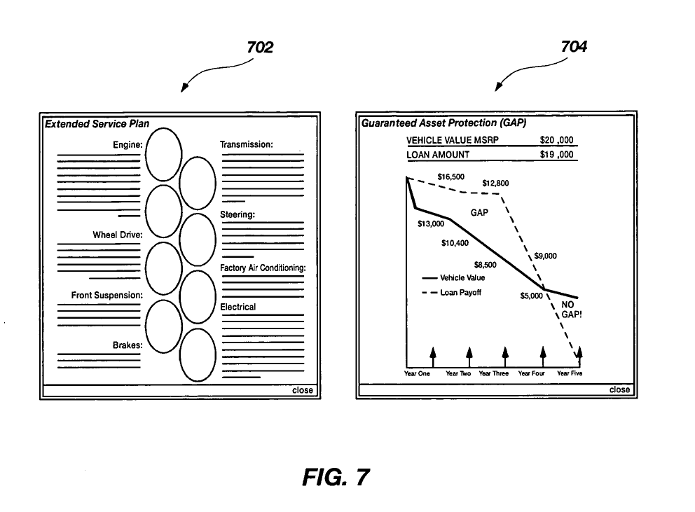

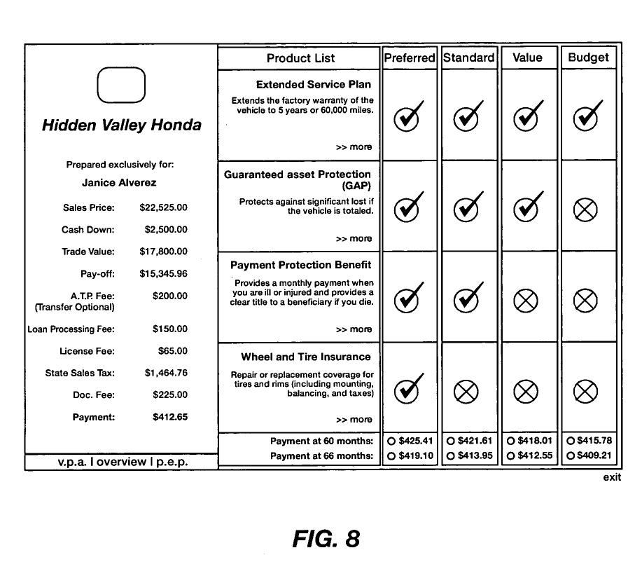

As each product or option within the bundled group or tier is discussed, the F&I presenter may display that product's e-brochure 702 to create a visual impression or a factual illustration 704, as shown in FIG. 7. The choice of e-brochure 702 or factual illustration 704 may be selected by the presenter in accordance with whichever display feature fits the customer's temperament trait (i.e., directness, extroversion, pace, or structure). Once all bundled groups are presented to the purchaser, a summary of the bundled groups are displayed side by side in order to make the customer's selection quick and easy, see FIG. 8.

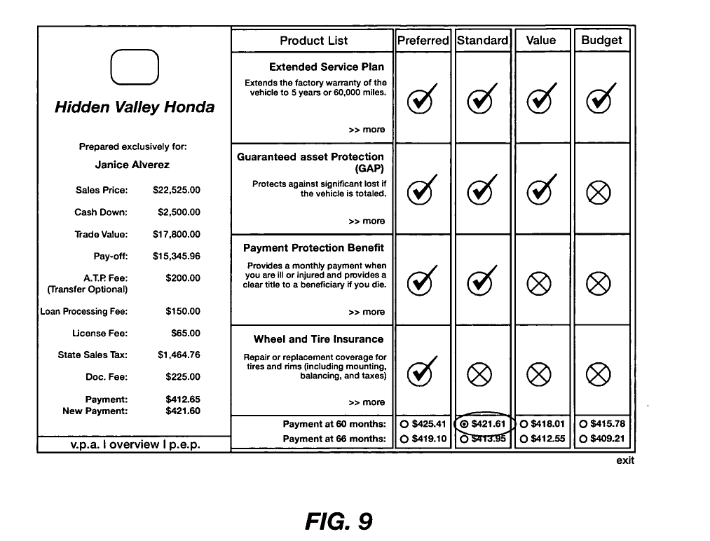

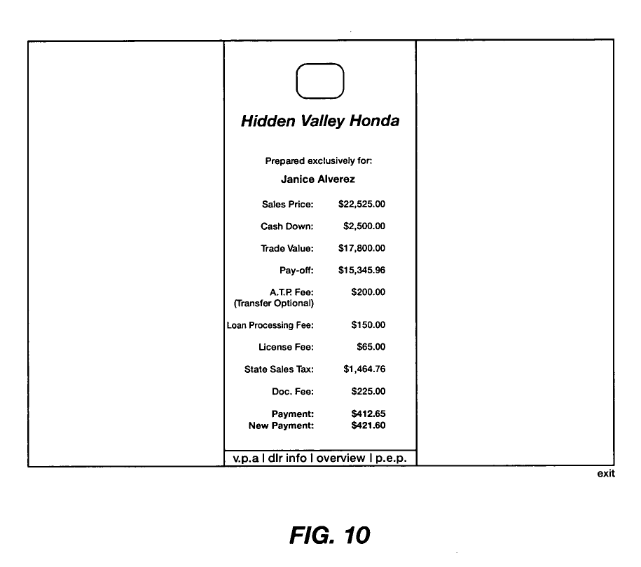

Referring to FIG. 9, if the customer makes a new selection, for example, from a 66 month payment plan to a 60 month payment plan, the new payment may be presented directly below the original payment in the left side summary and circled in the tier summary view (right-hand side). This creates a clear disclosure of the payment change. The methods of highlighting the change as shown in FIG. 9 (bolding and circling) are merely exemplary. Other suitable means of highlighting the new price are also within the scope of the present invention and may include, for example, changing font, color, size, blinking text, underlining and circling. Once a selection for a particular tier has been made, the tier selection portion of the display may be hidden to present only the summary information, see FIG. 10.

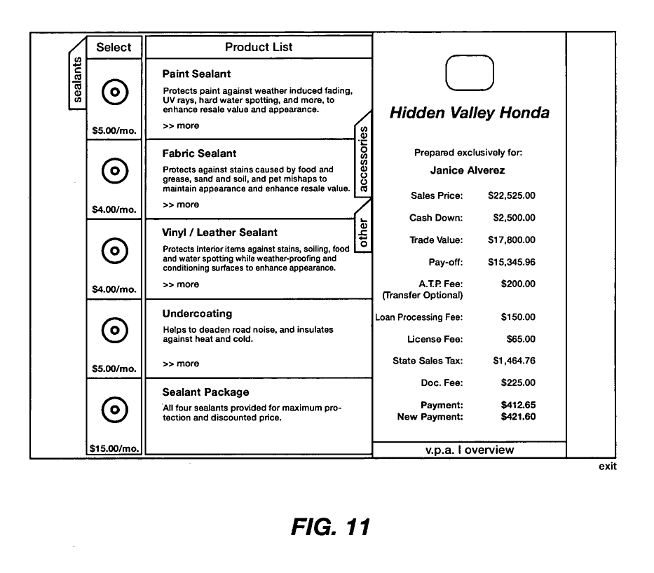

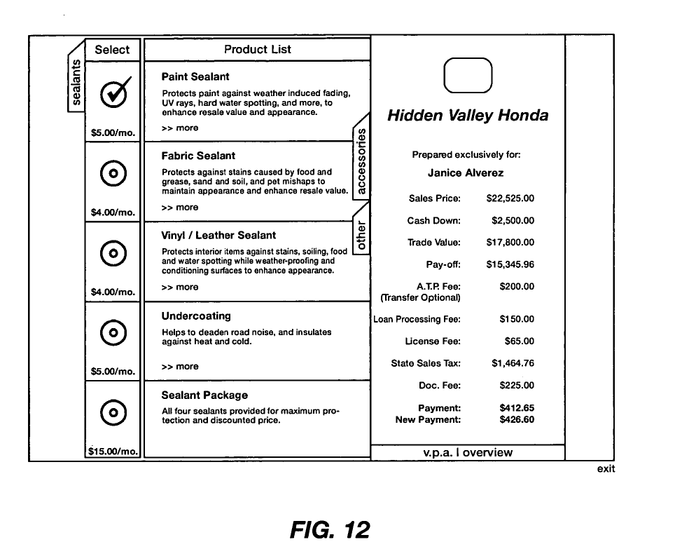

Using ExpressMenu™ the F&I presenter may then move to a similar style of presentation that displays other optional features of the property to be purchased, e.g., appearance package protection bundles. This presentation works in the same fashion offering illustrations that best fit the customer's temperament trait (directness, extroversion, pace, or structure), see FIG. 11. As shown in FIG. 11, these optional product payments may be presented as to what they would add to your monthly payment. Referring to FIG. 12, if paint sealant is selected (see check mark) $5.00 extra per month must be added to $421.60 to create a new payment of $426.60. Moving to a monthly add-on payment makes it easier for the purchaser to approve the new benefit.

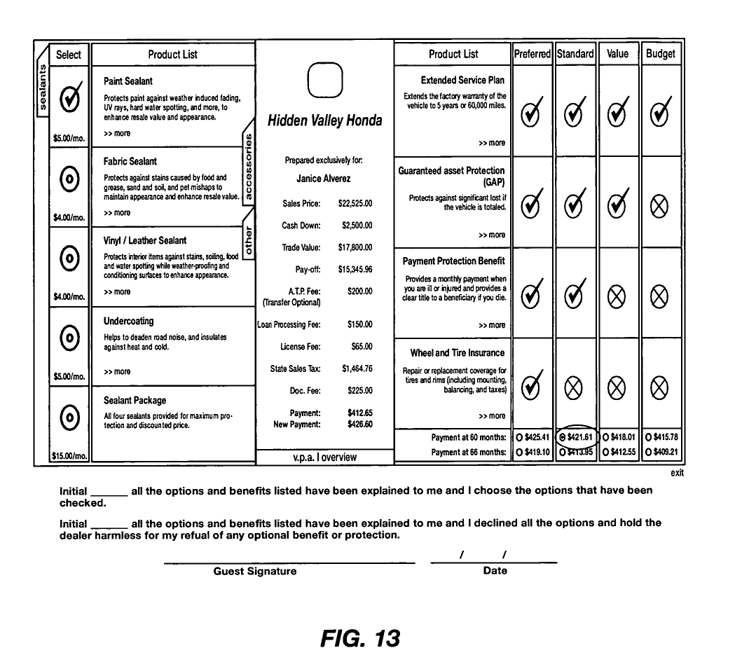

Finally at the end of the product presentation, the full presentation may be printed and signed by the customer, see FIG. 13. A copy of the presentation may be filed by the dealership to ensure against “false disclosure claims” by a purchaser because there will be a record of the purchaser's selection and how long such presentations were made. The ExpressMenu™ Menu selling presentation may be configured with proper disclosures occurring throughout the presentation in order to protect the dealer and the customer.

The ExpressMenu™ may also include a utilization feature according to an embodiment of the present invention. The utilization feature of ExpressMenu™ provides a time stamp report that shows how long the F&I presenter was in each screen and displaying to the purchaser. ExpressMenu™ may be configured with training for F&I presenters that includes scripts that go with each screen. ExpressMenu™ may be configured with a time stamp report comparing the actual time the user was in that screen to ideal script time. This feature gives the F&I presenter, dealership management and even a remote person or system an “e-coach” on a network (e.g., Internet) presentation data to compare to the F&I presenter's product penetration results. Where results are deficient the F&I presenter may be directed to the part of the presentation that needs work. The time stamp report also shows the F&I presenter the written script that goes with each screen.

The use of e-coaching allows review of the report and product penetration data along with role playing opportunity to close any actual or perceived performance gap. The e-coaching feature coupled with ExpressMenu™ Reports may eliminate geographic boundaries for ExpressMenu™ training, referred to herein as “e-training.” Thus, areas of the country that may not have been able to receive training due to travel restrictions, now have access to ExpressMenu™ e-training. With the reports available and the e-coaching feature, every F&I presenter may receive e-training.

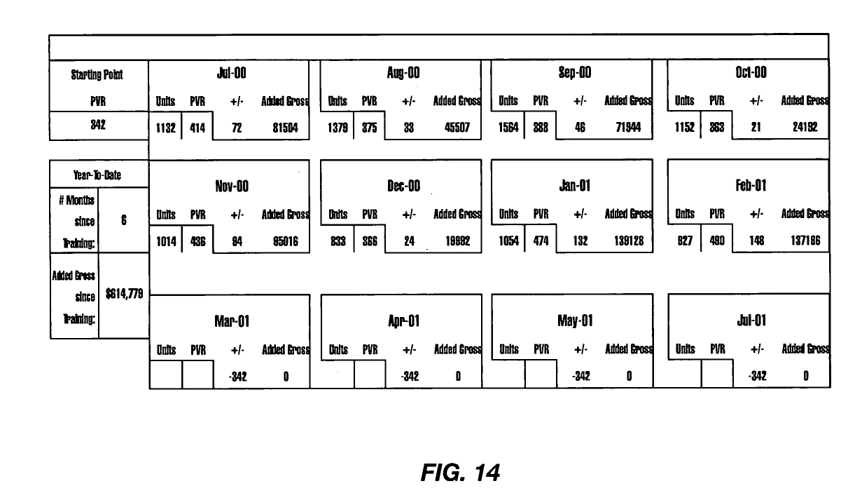

Yet another feature of the ExpressMenu™, a “then and now report”, may be included in an embodiment of the present invention, see FIG. 14. A “then and now report” may be made available over the Internet and records a Starting Point Per Vehicle Retail (PVR). The Starting Point PRV may also be referred to as the average gross per vehicle and may be compared to each current month's PVR and recorded as a year-to-date difference. By using a “then and now report” the dealer can now judge the value of ExpressMenu™, creating loyalty to the product and services. This report along with other ExpressMenu™ reports may show an e-coach and the F&I presenter where opportunities to improve sales performance exist.

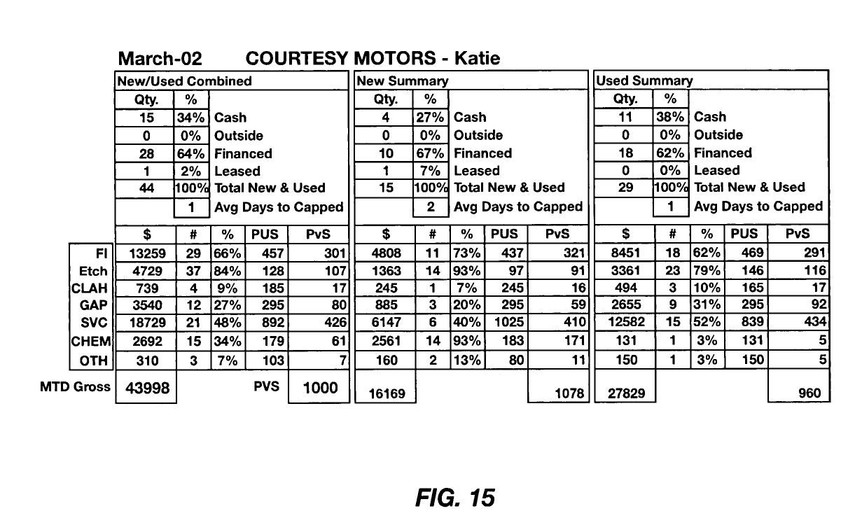

With the sales data gathered by the ExpressMenu™, additional statistics and reports may be generated according to embodiments of the present invention. One such report may be the F&I presenter's score card report, see FIG. 15. The score card report may be configured for Internet accessibility and may show results by product. This report guides the e-coach and F&I presenter to the sections of a sales presentation that may be weak. Using the score card report along with the time stamp report the e-coach and F&I presenter may be alerted to the presentation areas that may need attention.

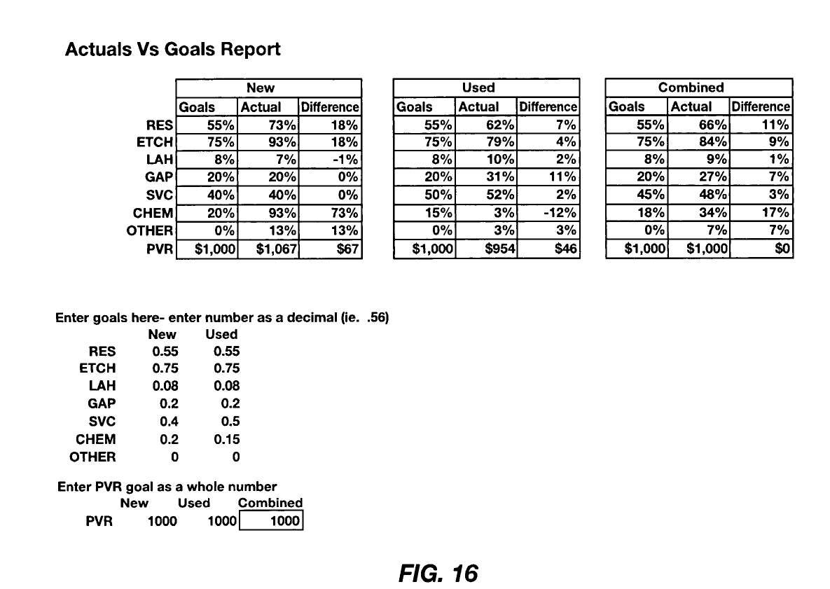

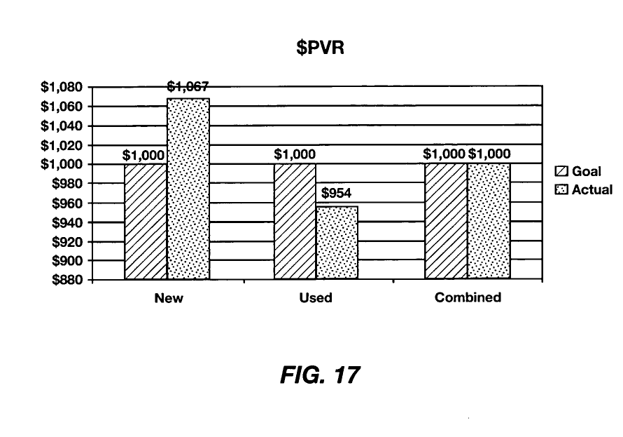

Yet another report consistent with the present invention is an actual vs. goals report which may also be configured for Internet accessibility, see FIG. 16. This actual vs. goals report may be valuable to the F&I presenter and e-coach to assist them to create goal setting and scorekeeping, see FIG. 17.

Once all the performance and software utilization reports have been reviewed by the F&I presenter and e-coach they are ready to conduct a coaching work sheet, according to another embodiment. A coaching worksheet may begin by stating the situation or status of sales as currently measured against average statistics and goals, according to an embodiment of the present invention. The coaching worksheet may then move on to an action that will be completed by whom and when, according to another embodiment of the present invention. Once actions are completed they may be posted on the worksheet by the person owning the action and an email may be automatically sent to the person who was promised the action, according to yet another embodiment of the present invention.

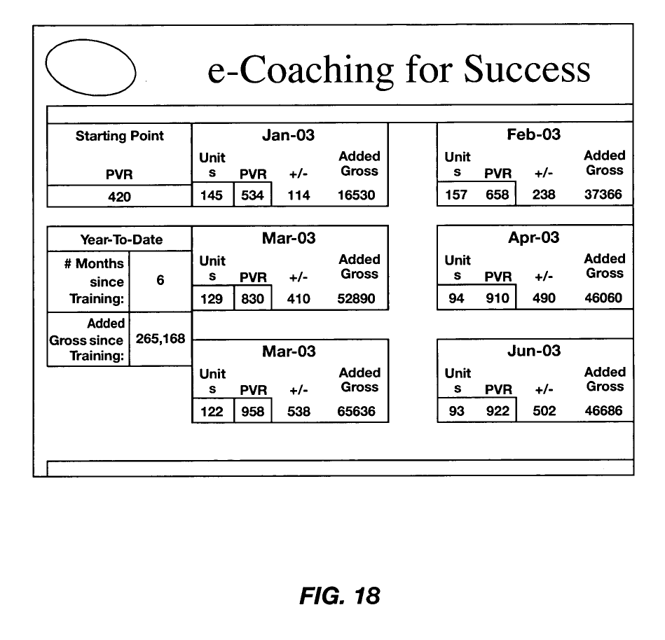

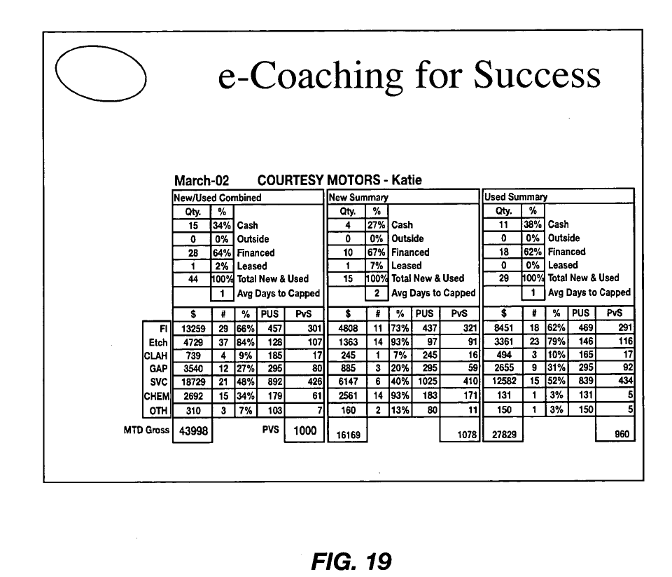

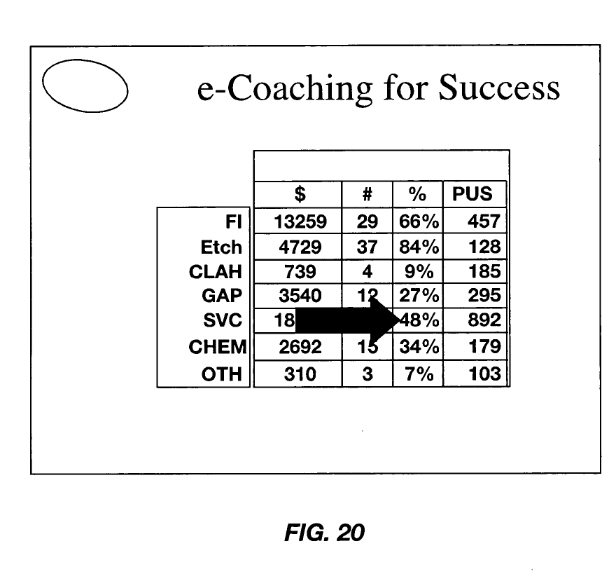

An example of e-Coaching worksheets is provided as FIGS. 18 through 22. In FIG. 18, this screenshot shows the results from each individual month. FIG. 19 shows provides a detailed performance review of an individual salesperson for a specific month. FIG. 20 is a close-up view of a portion of the detailed performance review shown in FIG. 19. The arrow indicates that the person reviewing performance only has to move and cursor and click on, for example, one of the percentages in the table. The result is to have a screen appear that provides specific information regarding that percentage.

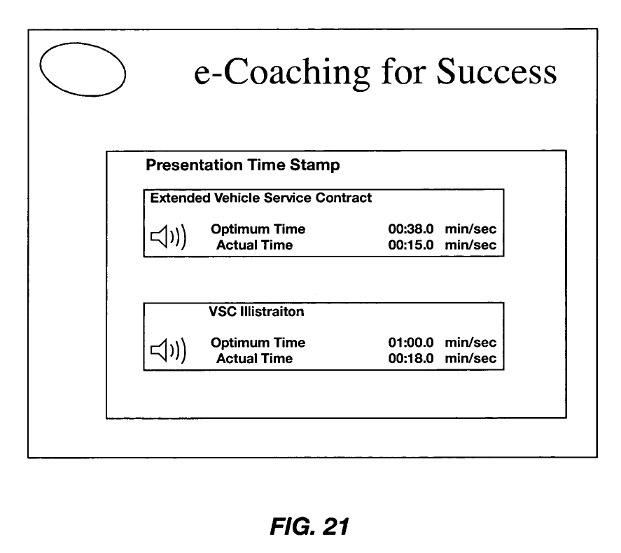

For example, FIG. 21 brings up the Presentation Time Stamp information that resulted in the given percentage. The screenshot indicates the optimum time that should be spent on that particular segment of the verbal presentation to the customer, and the actual time spent on the screen by the salesperson. Another helpful feature is the speaker symbol indicated on the left. IF the user clicks on the speaker symbol, the verbal segment is heard as spoken by an e-Coach or other person who presents the verbal segment in a desired manner for the salesperson to hear and study.

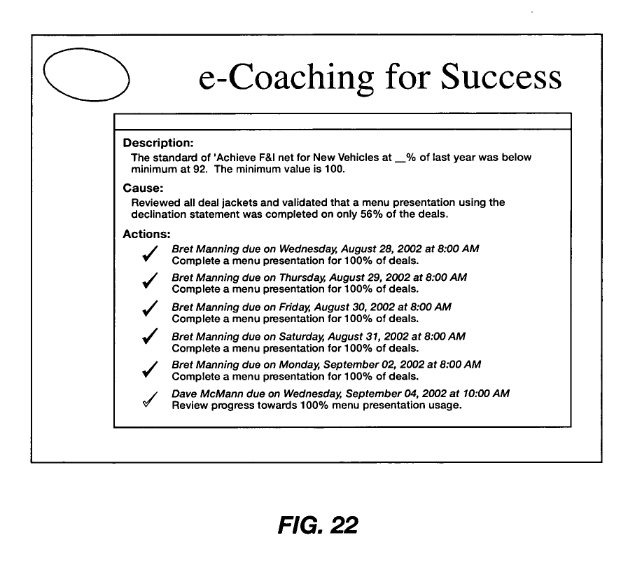

In order to help the salesperson meet specific goals that are agreed to with a manager at the dealership, FIG. 22 is a screenshot of an e-Coaching page that identifies a problem, the cause of the problem, and a list of actions that the salesperson has agreed to do. The actions are checked off one by one as they are completed. If an action is not completed within a predetermined period of time, such as 24 hours, then an email message is sent to the e-Coach and the designated senior dealership manager who is supposed to help the salesperson meet the assigned goals.

Advantageously, the present invention also sends an email to the designated senior dealership manager when a task is completed. With the potentially large number of salespersons that a manger may be responsible for, it becomes unwieldy to try and remember all the tasks that may have been assigned. Thus, the present invention takes care of that task and once the goal has been set, the system lets the designated senior dealership manager know when the tasks are and are not being completed.

While the foregoing advantages of the present invention are manifested in the illustrated embodiments of the invention, a variety of changes can be made to the configuration, design and construction of the invention to achieve those advantages. Hence, reference herein to specific details of the structure and function of the present invention is by way of example only and not by way of limitation.

1. A method for automating selection and tracking of purchase options for property sales transactions, comprising:
presenting a hierarchical list of options associated with purchase of property to a purchaser;
reviewing each of the options within the hierarchical list of options;
recording a purchaser's choices among all of the options; and
automatically summarizing selected options and highlighting the new cost associated with the property transaction.

2. The method according to claim 1, wherein presenting a hierarchical list of options comprises presenting a plurality of tiers ranging from an all-inclusive tier of options to a minimally-inclusive tier of options associated with the purchase of property.

3. The method according to claim 2, further comprising displaying only one of the plurality of tiers at a time.

4. The method according to claim 2, wherein presenting a plurality of tiers comprises presenting a preferred tier as the all-inclusive tier, a value tier including fewer options than the preferred tier, a basic tier with fewer options than the value tier and an economy tier as the minimally-inclusive tier of options.

5. The method according to claim 4, further comprising determining a purchaser's temperament.

6. The method according to claim 5, further comprising down selecting to a selected tier based on the purchaser's temperament.

7. The method according to claim 1, wherein presenting a hierarchical list of options includes mandatory disclosure options: extended service plan, guaranteed asset protection and payment protection benefit.

8. The method according to claim 1, wherein the property comprises an automobile.

9. The method according to claim 8, wherein presenting a hierarchical list of options includes at least one of paint protection, fabric protection, vinyl/leather protection, undercoating and clear bra.

10. The method according to claim 1, further comprising recording time duration elapsed during the reviewing each of the options within the hierarchical list of options.

11. The method according to claim 10, further comprising automatically gathering sales data and calculating statistics including time duration and purchaser choices over a plurality of sales.

12. The method according to claim 11, further comprising analyzing the statistics to determine sales personnel compliance with predetermined standard sales procedure.

13. The method according to claim 11, further comprising automatically calculating dealership sales performance based on the sales data during selected time periods.

14. The method according to claim 11, further comprising automatically calculating dealership sales performance based on the sales data on a per sale basis.

15. The method according to claim 1, wherein presenting a hierarchical list of options includes presenting financing and insurance options.

16. The method according to claim 1, further comprising validating a final selection by printing a report, obtaining a purchaser's physical signature and initials for options selected and declined on the report.

17. A computer media for storing a computer program, the computer program implementing a method for automating selection and tracking of purchase options for property sales transactions, the computer program configured to run on a computer, the method comprising:
presenting a hierarchical list of options associated with purchase of property to a purchaser;
reviewing each of the options within the hierarchical list of options;
recording a purchaser's choices among all of the options; and
automatically summarizing selected options and cost associated with the property transaction.

18. A system for automating selection and tracking of purchase options for property sales transactions, comprising:
an input device;
an output device; and
a processor in communication with the input device and the output device, the processor configured to execute a computer program; and
wherein the system is configured for:
presenting a hierarchical list of options associated with purchase of property to a purchaser on the output device;
allowing review of each of the options within the hierarchical list of options;
recording a purchaser's choices among all of the options using the input device; and
the processor automatically summarizing selected options and cost associated with the property transaction according to instructions in the computer program.

19. The system according to claim 18, wherein the system is further configured for monitoring the duration of time spent reviewing each of the options.

20. The system according to claim 18, wherein the system is further configured for disclosing mandatory disclosure items.

21. The system according to claim 18, wherein the system is further configured for remote access and monitoring by communication with a network.

22. The system according to claim 18, wherein the system is further configured for measuring sales performance against predefined goals.

23. The system according to claim 18, wherein the system is further configured for automatically rating sales personnel based on measuring human performance factors.

24. A method for presenting sales and finance options to a customer that enables highlighting customer responses and recording of customer selections, said method comprising the steps of:
presenting sales and finance options in a manner that is tailored to a customer's best method of understanding;
emphasizing at least one selection that the customer has made from the sales and finance options; and
recording the at least one selection.

25. The method as defined in claim 24 wherein the method further comprises the steps of:
printing a summary of the least one selection from the sales and finance options;
requiring the customer to sign the summary in order to archive proof that the sales and finance options were shown to the customer.

26. The method as defined in claim 25 wherein the method further comprises the steps of:
presenting a plurality of display screens to the customer using a computer program to present the sales and finance options to the customer;
associating with each of the plurality of display screens a timed verbal presentation; and
recording an amount of time that a presenter shows each of the plurality of display screens to the customer.

27. The method as defined in claim 26 wherein the method further comprises the steps of:
determining if the presenter is deficient in selling one or more of the plurality of sales and finance options; and
comparing the recorded amount of time that the presenter spends on each of the plurality of display screens to thereby determine if the presenter is spending a required amount of time to present each of the timed verbal presentations.
